(19) United States
(12) Patent Application Publication
(10) Pub. No.: US 2026/0364857 A1
(43) Pub. Date: Nov. 19, 2026

(54) PROCESSING HEAD WITH CUTTER AND ASSOCIATED CLEANING SYSTEM

(71) Applicant: Tritone Technologies Ltd., Rosh HaAyin (IL)

(72) Inventors: Eli KEDAR, Beit-Dagan (IL); Alon FELDMAN, Kibbutz Kfar-Menachem (IL); Ofer BEN-ZUR, Hod-HaSharon (IL); Boaz GLASS, Kfar Saba (IL)

(73) Assignee: Tritone Technologies Ltd., Rosh HaAyin (IL)

(21) Appl. No.: 19/143,927

(22) PCT Filed: Dec. 14, 2023
(86) PCT No.: PCT/IL2023/051272

§ 371 Date: Jun. 27, 2025

Related U.S. Application Data
(60) Provisional application No. 63/435,361, filed on Dec. 27, 2022.

(51) Int. Cl. B29C 33/38; B08B 1/12; B08B 1/34; B29C 64/30; B33Y 10/00; B33Y 40/20; B33Y 80/00

(52) U.S. Cl. CPC B29C 33/3842; B08B 1/12; B08B 1/34; B29C 64/30; B33Y 10/00; B33Y 40/20; B33Y 80/00

(57) ABSTRACT

A device for processing a waxy mold to smooth the mold to a predetermined smoothness or mold height and filling the mold with paste. The device has one or more cutting blades and a cleaning brush, and the cutting blade rotates over the wax to polish the wax to the predetermined smoothness or mold height. The cleaning brush comes into contact with the cutting blade to clean wax off of the cutting blade.

### RELATED APPLICATION/S

This application claims the benefit of priority of U.S. Provisional Patent Application No. 63/435,361 filed on 27 Dec. 2022, the contents of which are incorporated herein by reference in their entirety.

### FIELD AND BACKGROUND OF THE INVENTION

The present invention, in some embodiments thereof, relates to a processing head with a cutter and associated cleaning system and, more particularly, but not exclusively, to such a cutter for a layerwise additive manufacturing system that forms a layer by 3D printing of a mold and then filling the mold with a material that forms the layer.

In an additive manufacturing process, a layer is constructed by printing a mold and then filling the mold with material. The material may be a metal paste or ceramic paste and may typically be in a viscous liquid form. The process allows for metal and ceramic parts to be made, including machine parts, but machine parts are often specified to very high precision.

In general, the shape of the layer is defined by the printed mold and the mold is filled, and then the layer is dried and hardened. The drying process is carried out to extract binders and other liquid, and this may involve application of vacuum to the layer. The layer may be heated to harden the layer and once all the layers are formed, the part may be sintered to fuse the metal or other powder provided in the paste to form the part.

Referring now to FIG. 1, which illustrates the current art, a processing head 10 for additive manufacture comprises a die slot 12, a roller 14 and a knife 16.

A mold 18 is printed using 3D printing techniques and a suitable 3D printing material which is typically wax based. After printing the new mold layer 18, the roller 14, typically a heated cylinder, presses and flattens the mold surface slightly to make the surface of the mold more accurately defined.

Paste is then applied to the space defined within the mold via die slot 12. The paste is applied and spread within the mold by means of blade 14, for example a doctor blade.

The knife 14 then removes the excess paste from the mold surface. As the knife does so, there is a relative movement between the mold (the part been built) and the device 10.

However, the mold surface quality that is produced using the roller is not sufficient. It is difficult to control for variations in the thickness of the mold say due to different nozzles or blocks of nozzles in the 3D printing process. It is also very hard to get a good mold surface quality, and even after considerable calibration activity it is still not good or accurate.

### SUMMARY OF THE INVENTION

The present embodiments may use a cutting head having blades to polish the surface of the mold, instead of using a roller to flatten the surface. The cutting blade may thus polish the mold surface. The roller in fact pushes material aside and even causes distortion to the shape since it does not generally remove excess mold material. Accordingly, use of cutting blades allows greater precision with the result.

However, using cutting blades raises additional problems in that the mold material is typically soft and waxy and adheres to the cutting blade so that the blade has to be regularly cleaned.

Accordingly, various embodiments are provided for cleaning the cutting blades such as a brush, and furthermore, in some embodiments cooling is provided so that the wax becomes more rigid and is less likely to stick, thus making it easier to work with and to clean away.

According to an aspect of some embodiments of the present invention there is provided a device for processing a waxy mold to smooth the mold to a predetermined smoothness or mold height and filling the mold with paste, the device comprising at least one cutting blade and a cleaning brush, the at least one cutting blade being configured to rotate over the wax to polish the wax to the predetermined smoothness or mold height, and the cleaning brush being configured to come into contact with the at least one cutting blade to clean wax off of the cutting blade.

In an embodiment, the cutting blade is mounted on or built in to a cylinder, the cylinder being configured to rotate in a first direction while polishing the wax. An embodiment may use cutting blades mounted on or built into said cylinder.

In an embodiment, said cylinder is rotatable to bring each cutting blade into contact with said brush following said polishing of said wax.

In an embodiment, said cylinder is configured to rotate in a second direction when in contact with said cleaning brush.

In an embodiment, the cleaning brush is configured to move between a waiting position and a cleaning position, the cleaning position being in contact said cylinder and the waiting position being withdrawn from said cylinder.

In an embodiment, the cleaning brush is a rotary cleaning brush.

In an embodiment, the cylinder comprising said at least one cutting blade is configured to rotate in said first direction and the rotary cleaning brush is configured to rotate in a sense opposite to a sense of said first direction.

In an embodiment, the cleaning brush is configured to rotate to give a linear velocity which is faster than a linear velocity of the cutting blade.

Embodiments may utilize a coolant source to provide coolant to cool the mold or the cutting blade. In an embodiment, the coolant is provided to cool a surface of said at least one cutting blade or of said mold.

In an embodiment, the cylinder may have an inlet, an outlet and at least one internal hollow space leading from said inlet to said outlet for carrying said coolant to from said inlet to said outlet.

In an embodiment, said at least one internal hollow spaces is at a radial distance outward from a central axis of said shaft.

According to a second aspect of the present invention there is provided a method of additive manufacture comprising:
printing a mold defining a shape of a layer of a part;
polishing the mold using a cutting blade to define an upper surface of the mold to a predefined specification;
filling the mold with a paste; and
cleaning the blade.

In an embodiment of the method, the cutting blade is mounted on a cylinder, the cylinder rotating in a first direction while polishing the wax.

The method may comprise providing a plurality of cutting blades on said cylinder. The blades and cylinder may be integrally constructed, or the blades may be mounted using mountings.

The method may involve rotating said cyinder to bring each cutting blade successively into contact with said brush following polishing of said wax.

The method may involve rotating said cylinder in a second direction when in contact with said cleaning brush.

The method may involve moving the cleaning brush between a waiting position and a cleaning position, the cleaning position being in contact said cylinder and the waiting position being withdrawn from said cylinder.

In an embodiment of the method, the cleaning brush is a rotary cleaning brush.

The method may involve rotating the cylinder in said first direction and rotating the rotary cleaning brush in a sense opposite to a sense of said first direction.

In an embodiment of the method, the cleaning brush may rotate faster than the cutting blade.

The method may comprise providing coolant to cool the mold or the cutting blade.

The coolant may be provided externally to cool a surface of said at least one cutting blade or of said mold, or alternatively or additionally, said coolant may be carried within said cylinder.

In embodiments, the coolant is air.

According to a third aspect of the present invention there is provided a method of additive manufacture comprising:
printing a mold defining a shape of a layer of a part;
providing coolant to cool at least one of said mold and a surface of at least one cutting blade;
polishing the mold using said at least one cutting blade to define an upper surface of the mold to a predefined specification; and
filling the mold with a paste.

According to a fourth aspect of the present invention there is provided a device for processing a waxy mold to smooth the mold to a predetermined smoothness or mold height and to fill the mold with paste, the device comprising at least one cutting blade, the at least one cutting blade being configured to rotate over the wax to polish the wax to the predetermined smoothness or mold height, and a coolant source configure to provide coolant to cool at least one member of the group comprising the blade and the mold.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a diagram of a prior art processing head including a roller;

FIG. 2A is a diagram of a cutter with an associated cleaning brush according to a first embodiment of the present invention;

FIG. 2B is a variation of the cutter of FIG. 2A as a one-piece construction;

FIG. 3 is a cross-sectional diagram of the cutter of FIG. 2A, showing a blade of the cutter operating with the cleaning brush according to an embodiment of the present invention;

FIG. 4 is a cross-sectional diagram of a variation of the cutter of FIG. 2A in which a rotar brush is used, according to another embodiment of the present invention;

FIG. 5 is a cross-sectional view from the side of the cutter operating with a die slot and blade according to an embodiment of the present invention;

FIG. 6 is a diagram of the cutter of FIG. 2A with a hollow interior that may be connectd to a cooling source, according to another embodiment of the present invention;

FIGS. 7A and 7B are a cross-sectional and a cutaway view of the cutter of FIG. 6, showing internal passages for cooling fluid;

FIG. 8 is a simplified flow chart showing operation according to an embodiment of the present invention; and

FIG. 9 is a simplified flow chart showing an alternative operation according to a further embodiment of the present invention.

### DESCRIPTION OF SPECIFIC EMBODIMENTS OF THE INVENTION

The present invention, in some embodiments thereof, relates to a cutter and associated cleaning system and, more particularly, but not exclusively, to such a cutter for a layerwise additive manufacturing system that forms a layer by 3D printing of a mold and then filling the mold with a material that forms the layer.

The cutter is for polishing the mold, prior to filling the mold with paste, and may polish the waxy mold to smooth the mold to a predetermined smoothness or mold height, prior to filling the mold with paste. As long as the mold height is sufficiently precise, the paste may be smoothed the needed precision to make layers that are good enough for requirements, and may as necessary be suitable for precision machine parts and the like.

The cutter may include one or more cutting blades, which may be mounted on a rotary cylinder. The blades may be separate parts that are mounted on the cylinder or they may be integral to the cylinder. The cylinder is associated with a cleaning brush, and the cutting blades rotate over the wax to polish the upper surface of the wax to the predetermined smoothness or mold height. The cleaning brush then comes into contact with the cutting blades to clean wax off of the cutting blade. Wax left on the blades impairs the ability of the blade or blades to polish and smooth the wax to a precise surface.

The amount of wax shaved off the surface of the mold during the polishing process may typically be around 20 microns, and at such thicknesses, small amounts or residual wax on the cutting blade may lead to some distortion in the polishing process.

In an embodiment, the cutting blades rotate in one direction while polishing the wax and rotate in a second direction when in contact with the cleaning brush.

In embodiments, the cleaning brush may move between a waiting position and a cleaning position, the cleaning position being in contact with the cutting blade and the waiting position being withdrawn from the cutting blade. In this way the brush is not in contact with the cutting blades during polishing. In such an embodiment, the cleaning brush may be in the cleaning position when the cutting blades rotate in the second direction, that is the non-cleaning direction. Thus, if the blades cut while moving clockwise, cleaning will be carried out when it moves anti-clockwise, and vice versa.

In an embodiment, the brush may clean during polishing.

In an embodiment, the cleaning brush may rotate faster than the cylinder with the cutting blades, either in the same sense or in the opposite sense.

In an embodiment, a coolant source may provide coolant to cool the wax and make it less sticky and more brittle. Accordingly there is less fouling of the blade and the wax is easier to clean off.

The coolant may be cool air or other fluid.

The coolant may be provided via an inlet to a shaft of the cutter. The shaft may be hollow or include hollow passages for carrying the coolant along some or all of the length of the shaft to an outlet separated from the inlet. Thus the surfaces in contact with the wax, namely the cutting blades are cooled, with the same effect on the wax as described above. In a variant, coolant may alternatively or additionally be provided via a nozzle to the mold.

The internal hollow spaces may simply be the internal hollow area of the cylinder on which the cutting blades are mounted. There may there may be a hollow ring at at a radial distance outward from a central axis of the shaft.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

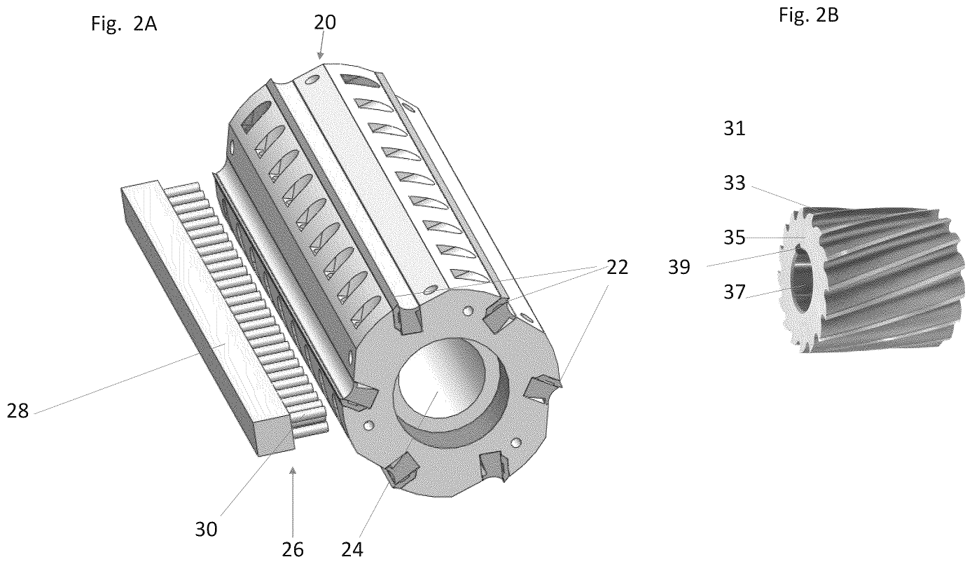

Referring now to FIG. 2A, cylinder 20 comprises cutting blades 22, a hollow central shaft 24 and is associated with a cleaning brush 26. The cleaning brush includes a brush head 28 and bristles 30, which may advantageously be tubelets. The tubelets may for example be nylon or other plastics.

As discussed above, the 3D printing material from which the mold is made is soft, and typically waxy, so that as the mold material is cut by the various blades 22, the mold material sticks to the blades. Accordingly the knife may require frequent cleaning otherwise the mold quality will be low. Mold material that sticks to the blade from a previous operation may leave marks on the mold surface in the following operation.

Current systems that use blades on wax may be manually cleaned, but manual cleaning requires the device to be stopped. Additive manufacture, where leveling is carried out on each layer and an individual product may be made of hundreds or even thousands of layers, could not be practical using manual cleaning.

In operation, the cylinder 20 rotates and blades 22 successively come into contact with the mold surface, thus polishing the mold. Following contact with the mold the blades then come into contact with the bristles 30 and residual wax from the mold is cleaned away from the blades 22.

In an alternative embodiment, the brush 26 is in a standby position during cutting or polishing. After polishing, the brush advances from a standby position to a cleaning position.

Reference is now made to FIG. 2B, which illustrates an alternative to the cutter of FIG. 2A. Cutter 31 is a monolithic construction in which the blades 33 are built in, that is formed integrally with, shaft 35. A hollow interior 37 has insert 39 into the shaft for definitive location.

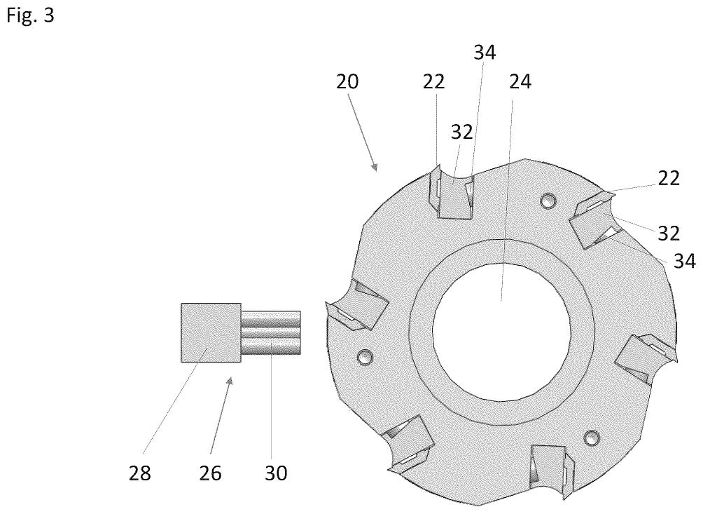

FIG. 3 is a simplified diagram illustrating a cross-section of the cylinder and cleaning brush of FIG. 2A. The same reference numerals are used, and are only referred to again as needed for an understanding of the present figure.

The cylinder 20 is generally round with a number of cutouts around the periphery into each of which a blade 22, a blade fitting 32 and a bolt 34 are inserted. In an embodiment the blade fitting may be springy and may be inserted after the blade to fix itself between the blade and the bolt to hold the blade against the bolt. The blade fitting may subsequently be released, for example using a suitably shaped key to replace the blade.

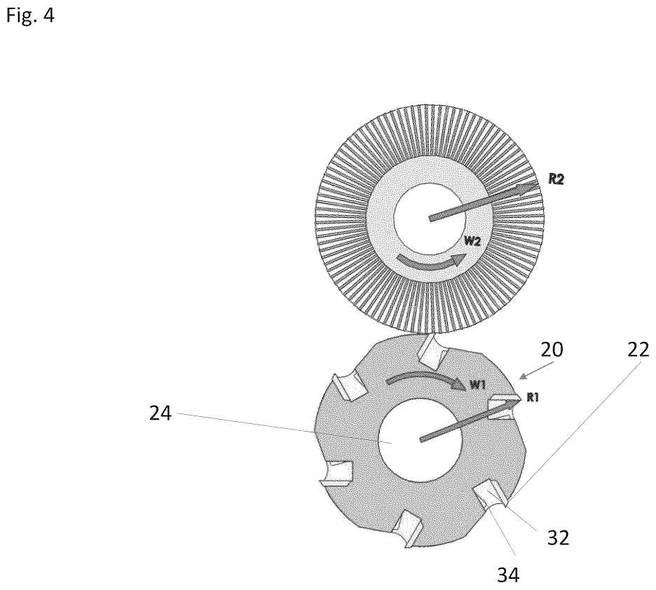

Reference is now made to FIG. 4, which is a simplified cross-sectional drawing showing the same cylinder but with a rotary brush. Parts of the cylinder that are the same as in the previous figures are given the same reference numerals and are not described again except as needed for understanding of the present figure. The cylinder 20 has blades extending outwards to a radius R1

As shown in FIG. 4, the brush 26 is replaced by a rotary brush 40. Rotary brush 40 has bristles 42 extending outward to a radius R2. The radius R2 is selected to allow the bristles to clean the cutting edges of the blades 22. The rotary brush 40 and the cutting cylinder 20 may rotate in opposite senses.

The outer edge of the blades travels at a linear velocity R1×W1. The outer edge of the brush travels at a linear velocity of R2×W2, and references herein to linear velocities of the blades or brush are intended to refer to these linear velocities of the outer edges thereof.

In embodiments the linear velocity of the brush is set to be greater than the linear velocity of the blades.

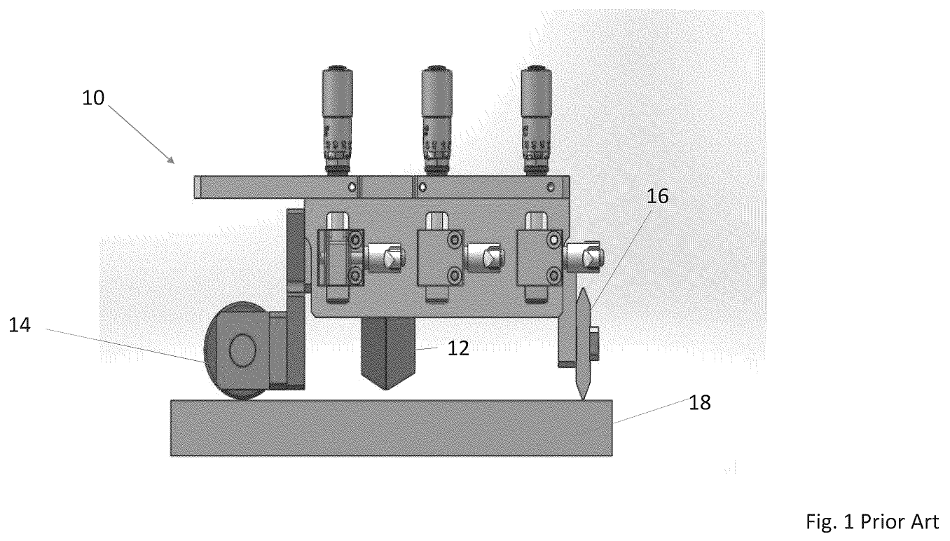

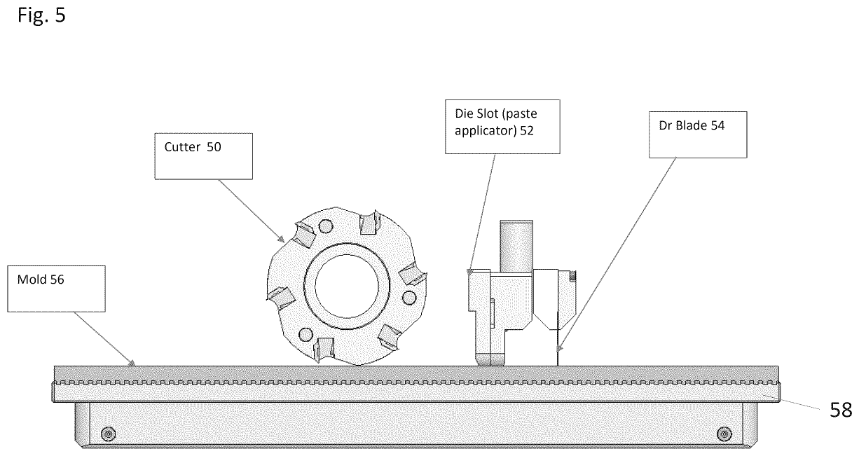

Reference is now made to FIG. 5, which is a simplified diagram illustrating a view from the side of a cutter 50 (here shown for simplicity without the cleaning brush) together with a die slot or paste applicator 52. It is to be noted that in contrast with FIG. 1, the die slot does not include a roller, although in embodiments the roller may be retained. Rather it includes a blade 54 for application of the paste, typically the product known as a doctor blade. The cutter 50 is in position over mold 56 to cut or polish the surface of the mold, and the die slot then fills paste within the space defined by the mold.

The mold may be printed on top of previous mold layers or may be printed directly on a printing tray 58.

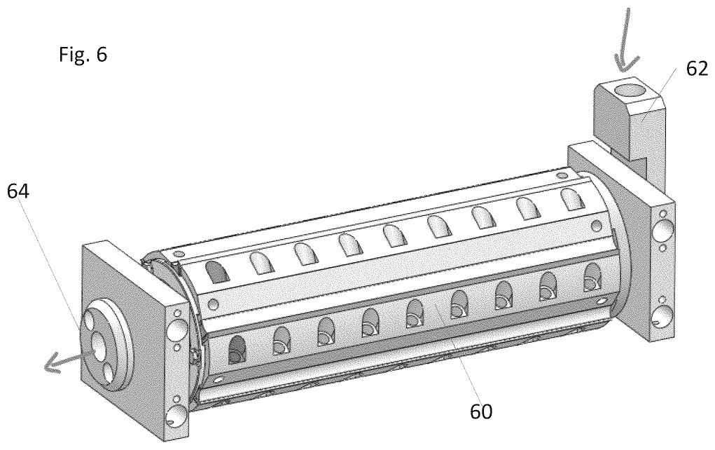

Reference is now made to FIG. 6, which is a simplified diagram illustrating a variation 60 of the cylinder 20 which is mounted so that the hollow within the cylinder is connected to a fluid inlet 62 and a fluid outlet 64. A source of cold air or other fluid (not shown) provides cold air for fluid inlet 62, and the fluid flows through the hollow from inlet 62 to outlet 64 and thus cools the cylinder. As a result the blades are cold, thus making the wax in contact with the blades more brittle Accordingly the wax smears less onto the blade and is knocked off more easily by the brush.

The source of cold air may for example be a cold air vortex cooling tool.

Additionally or alternatively, cold air may be provided directly onto the wax from a die slot or a nozzle. That is to say the mold surface may be cooled directly, which may be carried out together with or independently from cooling the cylinder from within. Direct cooling of the wax may prevent wax from accumulating on the blades and thus obviate the need for cleaning.

Thus according to an alternative embodiment of the present invention, the cutting blades are combined, not with a cleaning brush but rather with an outlet that directs coolant onto the wax to cool the wax prior to the polishing process. The coolant may be cold air and may be provided by a cold air vortex device.

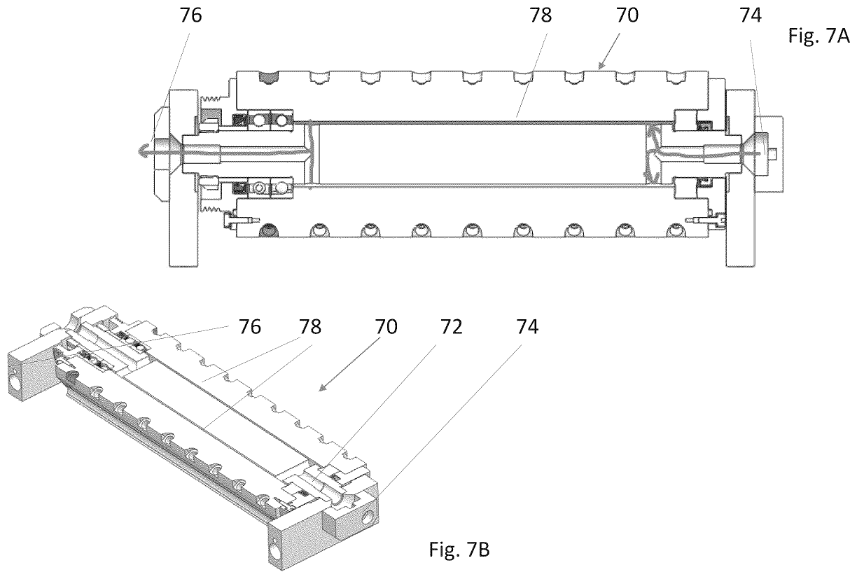

Reference is now made to FIGS. 7A and 7B, which are a cross-section and a cutaway view respectively of the cylinder 60 of FIG. 6.

As explained, cylinder 60 is hollow. Internal shaft 70 comprises an air inlet 74 and an outlet 76. The shaft 72 is hollow. Air or any other fluid from the cold air source may serve as a coolant as explained. The coolant enters the inlet 74 and travels through the shaft 72 from the inlet 74 to the outlet 76, accordingly cooling the cutting head and blade and thus reducing the stickiness of the wax coming into contact with the knife.

As shown, inlet 74 leads to a hollow ring 78 radially removed from the center of the shaft. Thus the cold air—or for that matter other fluid—passes closer to the periphery of the shaft, from where it is able to cool the blades.

FIG. 7B is a side cutaway view of the cutter head of the present embodiment, again showing the shaft 72, air inlet 74, outlet 76 and hollow ring 78.

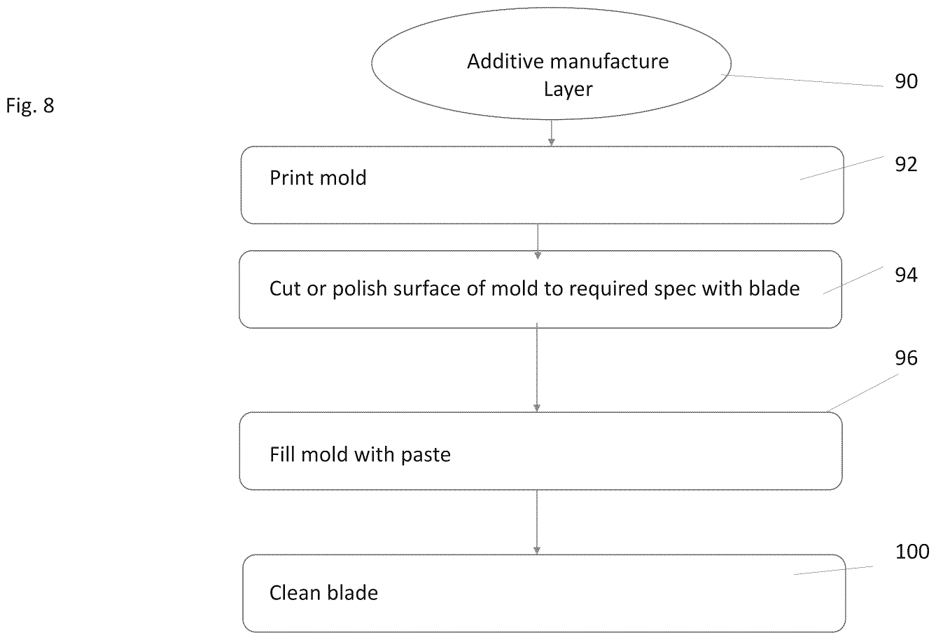

Reference is now made to FIG. 8, which is a simplified flow chart illustrating a method of additive manufacture according to embodiments of the present invention. The method 90 is carried out for each layer of the part or product being manufactured.

For each layer a mold is printed to define the outer boundary shape of the layer—92. As printed, the upper surface of the mold is not precise, possibly due to printing nozzles not working, or to different printing heads with different properties being involved in printing different parts of the mold. Thus a blade is used—94—to smooth the upper part of the mold to a predetermined specification. Unlike with a roller the smoothing involves actual polishing of the wax surface. Polishing is accordingly more precise than with the roller, where the wax is merely pressed and smeared. Typically an amount of wax of around 20 microns is shaved off in such a polishing operation.

Then the smoothed mold is filled with a paste-96. The paste contains the material making the part, for example the material may be metal or ceramic powder. The doctor blade discussed above may apply the paste to the hollow inside the mold after the paste exists the die slot.

The blade is cleaned in stage 100. Although shown as a separate stage, this is only true in some embodiments. In other embodiments cleaning is carried out concurrently with the cutting. Although the cleaning is shown after the filing stage it will often occur in practice before or concurrently with the filling stage, and the present figure is to be understood accordingly.

In other embodiments the cleaning stage is carried out separately from the polishing.

In embodiments the brush and cutting cylinder may rotate in opposite directions. In another embodiment, the blade may rotate in one direction while cutting wax of the mold and in a second direction when in contact with a cleaning brush for the cleaning stage.

As discussed in earlier embodiments, the cleaning stage may involve moving the cleaning brush between a waiting position and a cleaning position, the cleaning position being in contact with the cutting blade and the waiting position being distanced from the cleaning brush.

The cutting blades may rotate during cleaning in a direction opposite to that used during cutting.

During cutting, the cleaning brush may be retained in a waiting position, withdrawn from said cutting blade, when the cutting blade rotates in the first direction and cuts the wax.

Alternatively, the cutting blades rotate in a first direction to cut wax of the mold and for cleaning, a cleaning brush rotates in a second direction. In this case the cutting and cleaning may occur simultaneously.

In embodiments, the cleaning brush rotates at a linear velocity which is faster than that of the cutting blade. Again such an embodiment may be applicable to simultaneous cutting and cleaning.

The coolant may be provided via an inlet to a shaft of the processing head, the shaft comprising internal hollow spaces, the spaces carrying the coolant to an outlet separated from the inlet.

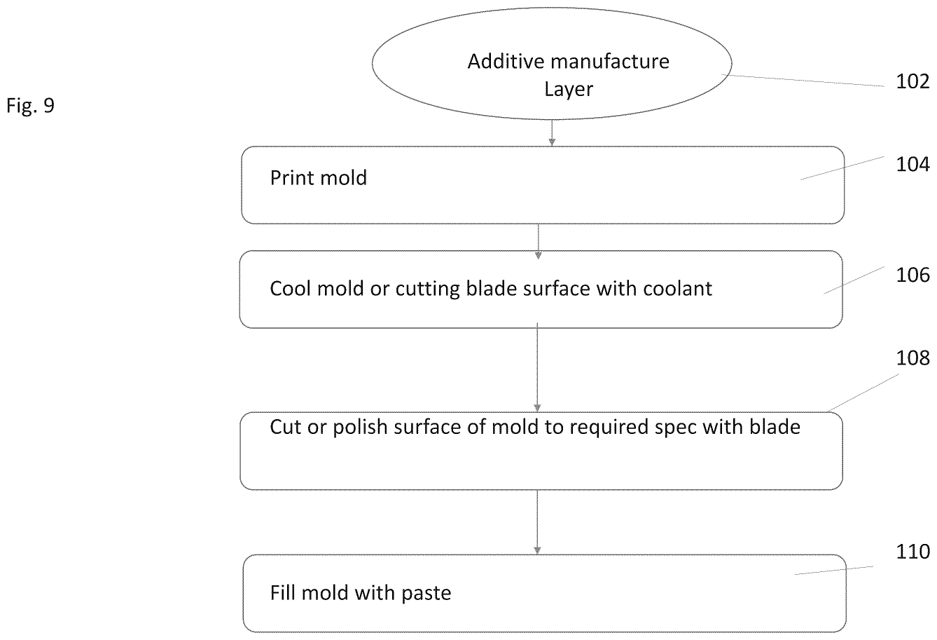

Reference is now made to FIG. 9, which illustrates an alternative embodiment in which a coolant source may provide coolant to cool the mold or the cutting blade externally—102.

The coolant may be air or any other suitable fluid.

In FIG. 9, stage 104 involves printing a mold defining the outer shape of the current layer.

In stage 106, coolant, typically air, is provided, say form a vortex device, and via a die slot or nozzle, to cool either or both of the mold and the cutting blade.

Stage 108 involves polishing the mold using the cutting blades as before to define an upper surface of the mold to a predefined specification. Then in stage 110 the mold is filled with a paste.

In the embodiment of FIG. 9, the coolant is thus introduced externally to the mold and/or blades. The embodiment may be used as an alternative to that of FIG. 8, but a further alternative is to use both together.

In the manufacture of each layer, a drying process is carried out to extract binders and other liquid, and this may involve application of vacuum to the layer. The layer may be heated to harden the layer and the part may be sintered to fuse the metal or other powder provided in the paste to form the part.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A device for processing a waxy mold to smooth the mold to a predetermined smoothness or mold height and filling the mold with paste, the device comprising at least one cutting blade and a cleaning brush, the at least one cutting blade being configured to rotate over the wax to polish the wax to the predetermined smoothness or mold height, and the cleaning brush being configured to come into contact with the at least one cutting blade to clean wax off of the cutting blade.

2. The device of claim 1, wherein the cutting blade is mounted on or built in to a cylinder, the cylinder being configured to rotate in a first direction while polishing the wax.

3. The device of claim 2, comprising a plurality of cutting blades mounted on or built into said cylinder.

4. The device of claim wherein said cylinder is rotatable to bring each cutting blade into contact with said brush following said polishing of said wax, or wherein said cylinder is configured to rotate in a second direction when in contact with said cleaning brush.

5. (canceled)

6. The device of claim 2, wherein the cleaning brush is configured to move between a waiting position and a cleaning position, the cleaning position being in contact said cylinder and the waiting position being withdrawn from said cylinder.

7. The device of claim 1, wherein the cleaning brush is a rotary cleaning brush.

8. The device of claim 6, wherein the cylinder comprising said at least one cutting blade is configured to rotate in said first direction and the rotary cleaning brush is configured to rotate in a sense opposite to a sense of said first direction.

9. The device of claim 1, wherein the cleaning brush is configured to rotate to give a linear velocity which is faster than a linear velocity of the cutting blade.

10. The device of claim 2, further comprising a coolant source to provide coolant to cool the mold or the cutting blade or to cool a surface of said at least one cutting blade or of said mold.

11. (canceled)

12. The device of claim 10, wherein the cylinder comprises an inlet, an outlet and at least one internal hollow space leading from said inlet to said outlet for carrying said coolant to from said inlet to said outlet.

13. The device of claim 12, wherein said at least one internal hollow spaces is at a radial distance outward from a central axis of said cylinder.

14. A method of additive manufacture comprising:
printing a mold defining a shape of a layer of a part;
polishing the mold using a cutting blade to define an upper surface of the mold to a predefined specification;
filling the mold with a paste; and
cleaning the blade.

15. The method of claim 14, wherein the cutting blade is mounted on a cylinder, the cylinder rotating in a first direction while polishing wax.

16. (canceled)

17. The method of claim 15, comprising rotating said cylinder to bring each cutting blade successively into contact with a cleaning brush following polishing of said wax.

18. The method of claim 17, comprising rotating said cylinder in a second direction when in contact with said cleaning brush.

19. The method of claim 17, comprising moving the cleaning brush between a waiting position and a cleaning position, the cleaning position being in contact said cylinder and the waiting position being withdrawn from said cylinder.

20. The method of claim 17, wherein the cleaning brush is a rotary cleaning brush.

21. The method of claim 20, comprising rotating the cylinder in said first direction and rotating the rotary cleaning brush in a sense opposite to a sense of said first direction.

22. The method of claim 17, wherein the cleaning brush is configured to rotate faster than the cutting blade.

23-26. (canceled)

27. A method of additive manufacture comprising:
printing a mold defining a shape of a layer of a part;
providing coolant to cool at least one of said mold and a surface of at least one cutting blade;
polishing the mold using said at least one cutting blade to define an upper surface of the mold to a predefined specification; and
filling the mold with a paste.

28. (canceled)
